(19) United States
(12) Patent Application Publication
(10) Pub. No.: US 2026/0264145 A1
(43) Pub. Date: Sep. 10, 2026

(54) METHOD FOR MANUFACTURING STRAIN WAVE GEAR

(71) Applicant: ILJIN GLOBAL HOLDINGS CO., LTD., Seoul (KR)

(72) Inventors: Ji Hun PARK, Seoul (KR); Woon Ju LEE, Yongin-si, Gyeonggi-do (KR); Dennis SANDNER, Langgoens (DE)

(73) Assignee: ILJIN GLOBAL HOLDINGS CO., LTD., Seoul (KR)

(21) Appl. No.: 19/491,404

(22) PCT Filed: Jun. 24, 2024
(86) PCT No.: PCT/KR2024/008695

§ 371 Date: Dec. 9, 2025

(30) Foreign Application Priority Data
Jun. 30, 2023 (KR) 10-2023-0084576

(51) Int. Cl. B22F 5/08; F16H 49/00; F16H 55/06; F16H 55/17

(52) U.S. Cl. CPC B22F 5/08; F16H 49/001; F16H 55/06; F16H 55/17; B22F 2301/35; B22F 2302/40; B22F 2302/45; F16H 2055/176

(57) ABSTRACT

A method for manufacturing a strain wave gear, includes: a ring-shaped internal gear having gear teeth provided on the inner diameter surface thereof and along the circumferential direction thereof and having multiple through-holes formed therethrough in the axial direction thereof; an external gear having gear teeth engaged with the gear teeth of the internal gear; a camshaft which is provided inside the external gear and has a wave generation portion on the outer diameter surface thereof; and a bearing provided between the external gear and the camshaft, the external gear including: a cylindrical portion having gear teeth on the outer diameter surface thereof in such a way as to engage with the gear teeth of the internal gear; a bottom on the end of the cylindrical portion; and a protruding portion protruding from the bottom in the axial direction thereof.

### TECHNICAL FIELD

The present invention relates to a method for manufacturing a strain wave gear, more specifically to a method for manufacturing a strain wave gear that is capable of being adequate for mass production of the strain wave gear and reducing a manufacturing cost of the strain wave gear.

### BACKGROUND ART

As shown in FIG. 1, a strain wave gear 100 is a type of a reducer and includes a ring-shaped internal gear (circular spline) 110 having gear teeth 115 on the inner periphery thereof, and an external gear (flexible gear) 120 as a flexible cylindrical body located inside the internal gear 110 and having gear teeth 123 on the outer periphery thereof, and a camshaft (wave generator) 140 located inside the external gear 120 and having an oval-shaped wave generation portion. A bearing 130 is located between the camshaft 140 and the external gear 120.

The internal gear 110 has a plurality of through holes in a circumferential direction thereof. In FIG. 1, a reference numeral 117 indicates an extension portion extending from the internal gear 110 in an axial direction of the internal gear 110.

The external gear 120 has a cylindrical portion 121 and bottom 125 having the shape of a cup and a protruding portion 127 protruding outward from the bottom 125, and the external gear 120 further has splines 129 formed on the inner periphery of the protruding portion 127. The gear teeth 123 are formed on the outer peripheral surface of the cylindrical portion 121.

The camshaft 140 has a projection 145 on one side thereof in an axial direction thereof in such a way as to lock the inner race of the bearing 130 thereonto, a concave portion 147 on the other side thereof in a circumferential direction thereof, and a wave generation portion 143 between the projection 145 and the concave portion 147.

In FIG. 1, a reference numeral 131 indicates the inner race, a reference numeral 133 an outer race, and a reference numeral 135 rolling elements aligned between the inner race 131 and the outer race 133 in a circumferential direction of the bearing 130. A plurality of rolling elements 135 are provided. The bearing 130 may be configured to allow the rolling elements 135 to come into direct contact with the wave generation portion 143, while having no inner race 131. Further, the bearing 130 may be configured to allow the rolling elements 135 to come into direct contact with the inner periphery of the cylindrical portion 121 of the external gear 120, while having no outer race 133, so that the cylindrical portion 121 may function as the external race.

A conventional method for manufacturing the parts 110, 120, and 140 constituting the strain wave gear 100 will be explained with reference to FIG. 5.

To manufacture the internal gear 110, a hollow body is made by means of forging or pipe cutting, and turning is carried out on the transverse surface, inner peripheral surface, and outer peripheral surface of the hollow body. Next, the plurality of through holes 113 are formed on the hollow body in the circumferential direction of the hollow body, and the gear teeth 115 are finally machined on the inner peripheral surface of the hollow body.

To manufacture the external gear 120, a round bar is cut, and the cut bar is forged to mold the shape of a cup having the protruding portion 127 on one side thereof. Next, turning is carried out on the inner and outer peripheral surfaces of the molded body, and the splines 129 passing through the protruding portion 127 are machined. After that, the gear teeth 123 are machined on the outer peripheral surface of the end portion of the cylindrical portion 121, and shot peening is performed on the machined surface. In the processes of turning the inner and outer peripheral surfaces of the external gear 120, both an inner peripheral surface turning device and an outer peripheral surface turning device are required.

To manufacture the camshaft 140, a round bar is cut, and turning is carried out on the cut bar to form the concave portion 147 on one side thereof and the projection 145 on the other side thereof. Next, turning is carried out to allow the oval-shaped wave generation portion 143 to be machined between the concave portion 147 and the projection 145.

According to the above-mentioned methods, as shown in FIG. 1, the gear teeth 115 of the internal gear 110 engage with the gear teeth 123 of the external gear 120, the bearing 130 is located inside the external gear 120, and the wave generation portion 143 is inserted into the bearing 130. Further, a snap ring (not shown) is inserted into the concave portion 147.

According to the conventional method for manufacturing the strain wave gear 100, all of the parts are manufactured by means of turning and gear teeth machining, thereby requiring much machining and extending cycle time, and quality variation becomes big according to machining conditions, thereby being not adequate for products that should be made in large quantities, such as, vehicles, and the like.

### DISCLOSURE

### Technical Problem

It is an object of the present invention to provide a method for manufacturing a strain wave gear that is capable of reducing a manufacturing cost of a product, decreasing cycle time in manufacturing the product, and making quality variation lowered to achieve adequateness in mass production.

### Technical Solution

To accomplish the above-mentioned objects, according to the present invention, there is provided a method for manufacturing a strain wave gear, and the strain wave gear may include a ring-shaped internal gear having gear teeth on the inner periphery thereof and a plurality of through holes in a circumferential direction thereof in such a way as to pass therethrough in an axial direction thereof, an external gear having gear teeth engaging with the gear teeth of the internal gear, a camshaft located inside the external gear and having a wave generation portion on the outer periphery thereof; and a bearing located between the external gear and the camshaft.

The external gear may include a cylindrical portion having the gear teeth on the outer periphery thereof in such a way as to engage with the gear teeth of the internal gear, a bottom on the end portion of the cylindrical portion, and a protruding portion protruding from the bottom in an axial direction thereof.

The method for manufacturing the strain wave gear according to the present invention may include the step of manufacturing one or more of the internal gear, the external gear, and the camshaft by means of sintering.

In the above, the internal gear, the external gear, and the camshaft may be manufactured by means of the sintering.

In the above, the internal gear and the camshaft may be manufactured by means of the sintering, while the external gear may be manufactured by means of turning the outer peripheral surface of the cylindrical portion of a sintered molded body after sintered and by means of machining of the gear teeth on the outer peripheral surface thereof after the turning, so that the internal gear, the camshaft, and the external gear are coupled to the bearing.

In the above, the internal gear may be manufactured by means of the sintering and made of a sintering material containing 0.35 to 0.45% by weight of carbon (C), 1.4 to 1.8% by weight of nickel (Ni), 2.4 to 2.6% by weight of chromium (Cr), and the remaining percentage by weight of iron, while selectively containing a trace element.

In the above, the external gear may be manufactured through steps of: sintering the sintering material to make the sintered molded body comprising the cylindrical portion, the bottom on the end portion of the cylindrical portion, and the protruding portion protruding from the bottom; turning the outer peripheral surface of the sintered molded body, and machining the gear teeth on the outer peripheral surface of the cylindrical portion.

The bearing may be inserted into the inner peripheral surface of the cylindrical portion on which the turning has been carried out.

In the above, the external gear may be manufactured by means of the sintering and made of a sintering material containing 0.35 to 0.45% by weight of carbon (C), 0.1 to 0.35% by weight of molybdenum (Mo), 2.4 to 2.6% by weight of chromium (Cr), and the remaining percentage by weight of iron, while selectively containing a trace element.

In the above, the external gear may be manufactured by means of the sintering and made of a sintering material containing 0.35 to 0.45% by weight of carbon (C), 0.1 to 0.35% by weight of molybdenum (Mo), 2.4 to 2.6% by weight of chromium (Cr), and the remaining percentage by weight of iron, while selectively containing a trace element.

In the above, the internal gear may have hardness in the range between 34 and 42 HRc, and the external gear may have hardness in the range between 38 and 46 HRc, which is higher than the hardness of the internal gear.

### ADVANTAGEOUS EFFECTS OF INVENTION

According to the present invention, the method for manufacturing the strain wave gear makes the strain wave gear at a low manufacturing cost, enables material loss to be greatly reduced, allows cycle time in manufacturing the product to decrease, and makes quality variation £ lowered to achieve adequateness in mass production.

### BRIEF DESCRIPTION OF DRAWINGS

FIG. 1 is a sectional view showing a strain wave gear.

FIG. 2 is a perspective view showing an internal gear of the strain wave gear.

FIG. 3 is a perspective view showing an external gear of the strain wave gear.

FIG. 4 a perspective view showing a camshaft of the strain wave gear.

FIG. 5 is a flowchart showing a conventional method for manufacturing the strain wave gear.

FIG. 6 is a flowchart showing a method for manufacturing the strain wave gear according to the present invention.

### MODE FOR INVENTION

All terms used herein, including technical or scientific terms, unless otherwise defined, have the same meanings which are typically understood by those having ordinary skill in the art. The terms, such as ones defined in common dictionaries, should be interpreted as having the same meanings as terms in the context of pertinent technology, and should not be interpreted as having ideal or excessively formal meanings unless clearly defined in the specification.

The terms “having,” “including,” “containing” and similar referents in the specification and in the following claims are to be construed as open-ended terms (e.g., meaning “including, but not limited to, ”) unless otherwise noted.

An expression referencing a singular value additionally refers to a corresponding expression of the plural number, unless explicitly limited otherwise by the context.

When it is said that one element is described as being “connected” or “coupled” to the other element, one element may be directly connected or coupled to the other element, but it should be understood that another element may be present between the two elements.

Hereinafter, a method for manufacturing a strain wave gear according to the present invention will be described in detail with reference to the accompanying drawings.

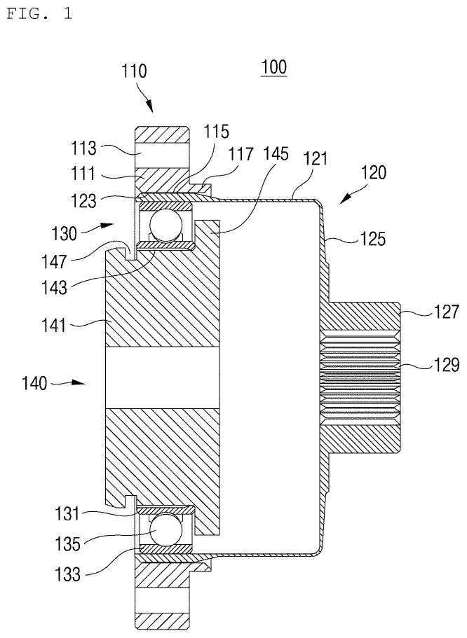

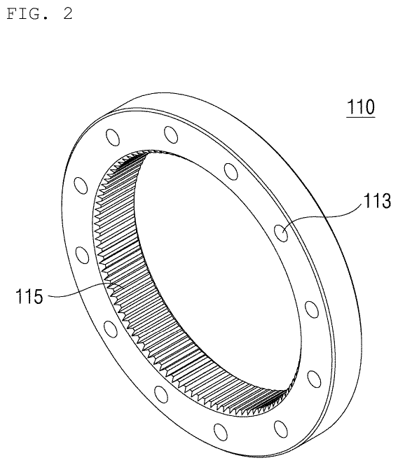

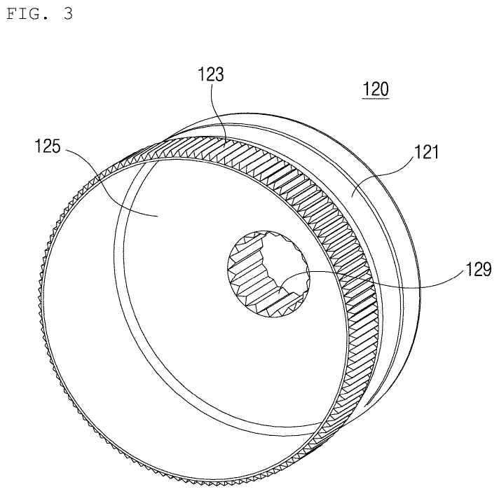

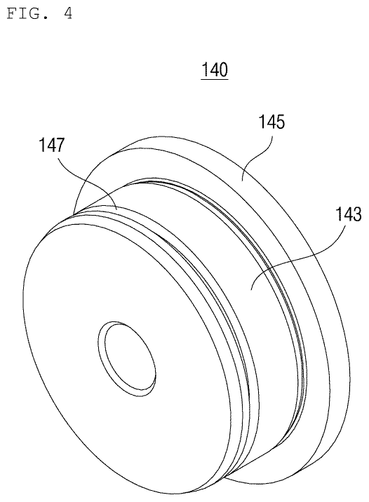

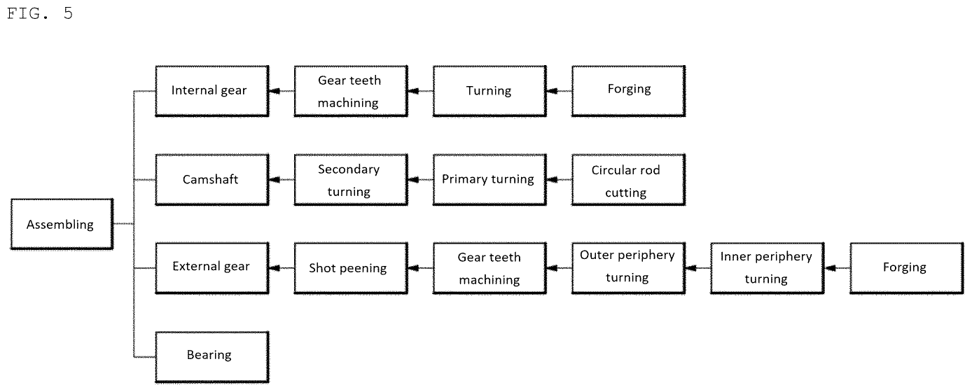

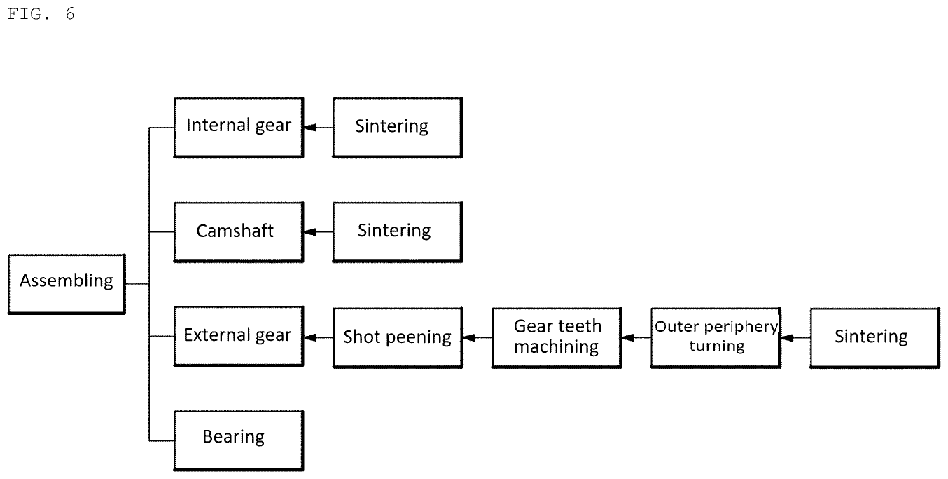

FIG. 1 is a sectional view showing a strain wave gear, FIG. 2 is a perspective view showing an internal gear of the strain wave gear, FIG. 3 is a perspective view showing an external gear of the strain wave gear, FIG. 4 a perspective view showing a camshaft of the strain wave gear, FIG. 5 is a flowchart showing a conventional method for manufacturing the strain wave gear, and FIG. 6 is a flowchart showing a method for manufacturing the strain wave gear according to the present invention.

In the description, a horizontal direction of FIG. 1 means an axial direction, and a vertical direction thereof means a radial direction.

As shown in FIG. 1, the strain wave gear 100 includes the internal gear 110, the external gear 120, the camshaft 140, and the bearing 130.

The internal gear 110 has the shape of a ring. The internal gear 110 has the gear teeth 115 on the inner periphery thereof. The gear teeth 115 are formed along the inner periphery of the internal gear 110. The internal gear 110 has a plurality of through holes 113 spaced apart from one another: a circumferential direction thereof in such a way as to pass therethrough in an axial direction thereof. The internal gear 110 is fixedly built by inserting fixing members such as bolts and the like into the through holes 113.

The reference numeral 117 of FIG. 1 indicates the extension portion protruding from the internal gear 110 toward one side thereof in the axial direction thereof.

The external gear 120 is located inside the internal gear 110 in the axial direction of the internal gear 110. The external gear 120 is formed of a cylindrical hollow body that is open toward one side thereof in the axial direction thereof. The external gear 120 includes the cylindrical portion 121, the gear teeth 123, the bottom 125, and the protruding portion 127.

The cylindrical portion 121 is a hollow body that is open in the axial direction and has the sectional area of a circle. The cylindrical portion 121 has a low thickness, for example, a thickness in the range between 0.2 and 0.5 mm. The cylindrical portion 121 is located inside the internal gear 110 in the axial direction. The internal gear 110 is located at one side of the cylindrical portion 121 in the axial direction of the cylindrical portion 121.

The gear teeth 123 are formed on the outer periphery of the cylindrical portion 121. The gear teeth 123 are formed in the circumferential direction on one side end periphery of the cylindrical portion 121 in the axial direction. The gear teeth 123 formed on the outer periphery of the cylindrical portion 121 engage with the gear teeth 115 of the internal gear 110. The number of gear teeth 123 of the external gear 120 is smaller than the number of gear teeth 115 of the internal gear 110.

The bottom 125 is located on the other side end portion of the cylindrical portion 121. The bottom 125 is located on the opposite side of the cylindrical portion 121 to one side where the gear teeth 123 are formed.

The protruding portion 127 protrudes from the bottom 125 in the axial direction. The protruding portion 127 protrudes from the bottom 125 toward the opposite side to one side where the internal gear 110 is located. The protruding portion 127 has a thickness higher than the cylindrical portion 121, for example, a thickness in the range between 1 and 5 mm. The protruding portion 127 is open on both sides thereof in the axial direction. The protruding portion 127 has splines 129 on the inner periphery thereof.

The camshaft 140 is located inside the external gear 120. The camshaft 140 is spaced apart from the external gear 120 in such a way as to be located inside the external gear 120 in the radial direction. The camshaft 140 includes a shaft body 141, the wave generation portion 143, the projection 145, and the concave portion 147.

The shaft body 141 is located inside the external gear 120 in the radial direction. One side of the shaft body 141 in the axial direction protrudes outward from the open portion of the external gear 120 in the axial direction. The shaft body 141 has the sectional area of a circle. The shaft body 141 has a shaft hole passing through the central portion thereof in such a way as to insert a shaft (not shown) thereinto in the axial direction.

The wave generation portion 143 is formed on the outer peripheral surface of the shaft body 141. The wave generation portion 143 has the sectional area of an oval. The wave generation portion 143 may be formed of a plurality of protrusions (e.g., three protrusions) equally spaced apart from one another in the circumferential direction thereof. Each protrusion has an inscribed angle smaller than the inscribed angle forming the circumferential direction of the wave generation portion 143.

The concave portion 147 is concavely formed on the outer peripheral surface of the shaft body 141 in the circumferential direction of the shaft body 141. The concave portion 147 is formed on one side of the shaft body 141 around the wave generation portion 143 in the axial direction. The concave portion 147 is formed on a given position of the shaft body 141 that protrudes from the open portion of the external gear 120 toward the outside in the axial direction. The snap ring is inserted into the concave portion 147 to prevent the bearing 130 into which the camshaft 140 is inserted from escaping therefrom.

The projection 145 is formed on the outer peripheral surface of the shaft body 141. The projection 145 protrudes outward from the shaft body 141 in the radial direction. The projection 145 is formed on the other side of the shaft body 141 around the wave generation portion 143 in the axial direction. The projection 145 protrudes outward from the shaft body 141 in the radial direction in such a way as to allow the bearing 130 into which the camshaft 140 is inserted to be locked thereonto.

The bearing 130 has the shape of a ring. The bearing 130 is located between the external gear 120 and the camshaft 140 in the radial direction.

The bearing 130 includes the ring-shaped inner race 131 having an inner raceway on the outer periphery thereof, the ring-shaped outer race 133 having an outer raceway on the inner periphery thereof, and the plurality of rolling elements 135 aligned between the inner race 131 and the outer race 133 in the circumferential direction thereof. The rolling elements 135 are formed of spherical balls or cylindrical rollers.

The camshaft 140 is inserted into the inner race 131 of the bearing 130 in such a way as to allow one side of the bearing 130 in the axial direction to be locked onto the projection 145 thereof. The bearing 130 is located to allow the inner race 131 to be locked onto the projection 145 of the camshaft 140.

In the above, the bearing 130 may be configured to allow the rolling elements 135 to come into direct contact with the wave generation portion 143, while having no inner race 131. Further, the bearing 130 may be configured to allow the rolling elements 135 to come into direct contact with the inner periphery of the cylindrical portion 121 of the external gear 120, while having no outer race 133, so that the cylindrical portion 121 may function as the external race.

Hereinafter, an explanation of a method for manufacturing the strain wave gear according to the present invention will be given with reference to FIG. 6.

The internal gear 110, the external gear 120, the camshaft 140, and the bearing 130 are manufactured and put together to provide the strain wave gear 100.

The internal gear 110 is made through sintering, and it's manufacturing is completed through the sintering.

A sintering material, which is used to make the internal gear 110, contains 0.35 to 0.45% by weight of carbon (C), 1.4 to 1.8% by weight of nickel (Ni), 2.4 to 2.6% by weight of chromium (Cr), and the remaining percentage by weight of iron. The sintering material for making the internal gear 110 may selectively contain a trace element. In this case, a trace element (in an amount range of 0.01% by weight or less) such as vanadium (V) is present in the sintering material.

If carbon (C) is present in the sintering material in an amount range of less than 0.35% by weight, a density of a core may decrease upon heat treatment, and if carbon (C) is present in the sintering material in an amount range of greater than 0.45% by weight, impact resistance may decrease due to brittleness after the heat treatment.

If nickel (Ni) is present in the sintering material in an amount range of less than 1.4% by weight, desired harness and strength may not be obtained and corrosion resistance may decrease, and if nickel (Ni) is present in the sintering material in an amount range of greater than 1.8% by weight, brittleness may be generated to have low impact resistance and abrasion resistance may become deteriorated badly.

If chromium (Cr) is present in the sintering material in an amount range of less than 2.4% by weight, mechanical properties of the material may become deteriorated, and if chromium (Cr) is present in the sintering material in an amount range of greater than 2.6% by weight, a material cost may increase, formability may decrease, and upon sintering, chromium (Cr) may be oxidized.

An internal gear molded body is made of the sintering material constituting the internal gear 110, and to do this, the sintering material is heated at a temperature in the range between 1180 and 1300° C. and thus sintered. If the sintering temperature is less than £ 1180° C., materials among powdered particles do not diffuse smoothly, and if the sintering temperature is greater than 1300° C., mass production may become deteriorated remarkably.

The internal gear 110 made by means of the sintering has hardness in the range between 34 and 42 HRc. The internal gear 110 should function as a rigid body maintaining the round shape during its operation, and therefore, the sintering material containing the above elements is used to ensure high hardness and wear resistance.

A method for manufacturing the external gear 120 includes the steps of sintering a sintering material to make a sintered molded body, turning the outer periphery of the sintered molded body, machining the gear teeth 123, and performing shot peening.

In the step of sintering the sintering material, the sintering material is sintered to make the sintered molded body. The sintered molded body has a thickness in the range between 1 and 5 mm. The sintered molded body has the cylindrical portion 121, the bottom 125 located on the end portion of the cylindrical portion 121, and the protruding portion 127 protruding from the bottom 125. Further, the splines 129 are formed on the inner peripheral surface of the protruding portion 127 in the sintering step.

The sintering material, which is used to make the external gear 120, contains 0.35 to 0.45% by weight of carbon (C), 0.1 to 0.35% by weight of molybdenum (Mo), 2.4 to 2.6% by weight of chromium (Cr), and the remaining percentage by weight of iron. The sintering material for making the external gear 120 may selectively contain a trace element. In this case, a trace element (in an amount range of 0.01% by weight or less) such as vanadium (V) is present in the sintering material.

If carbon (C) is present in the sintering material in an amount range of less than 0.35% by weight, a density of a core may decrease upon heat treatment, and if carbon (C) is present in the sintering material in an amount range of greater than 0.45% by weight, impact resistance may decrease due to brittleness after the heat treatment.

If molybdenum (Mo) is present in the sintering material in a small amount range, hardenability, corrosion resistance, and toughness may increase, but if molybdenum (Mo) is present in the sintering material in an amount range of greater than 0.35% by weight, brittleness may be generated to have low impact resistance.

If chromium (Cr) is present in the sintering material in an amount range of less than 2.4% by weight, mechanical properties of the material may become deteriorated, and if chromium (Cr) is present in the sintering material in an amount range of greater than 2.6% by weight, a material cost may increase, formability may decrease, and upon sintering, chromium (Cr) may be oxidized.

A sintered molded body is made of the sintering material constituting the external gear 120, and the sintering material is heated at a temperature in the range between 1180 and 1300° C. and thus sintered. If the sintering temperature is less than 1180° C., materials among powdered particles do not diffuse smoothly, and if the sintering temperature is greater than 1300° C., mass production may become deteriorated remarkably.

The external gear 120 is a part that is elastically deformed according to the rotation of the camshaft 140, and it is made of the sintering material containing the above elements and has sufficient hardness and durability. The external gear 120, which is made of the sintering material containing the above elements, has hardness in the range between 38 and 46 HRc and fatigue limit (fatigue bending stress R=−1) greater than or equal to 350 Mpa.

The external gear 120 has hardness greater than the internal gear 110. Desirably, the external gear 120 has hardness in the range between 38 and 46 HRc, and the internal gear 110 has hardness in the range between 34 and 42 HRc.

The external gear 120 is a part that is elastically deformed by the external force received from the bearing 130 according to the rotation of the camshaft 140. Therefore, the internal gear 110 has stiffness substantially greater than the external gear 120, and even while the camshaft 140 rotates, desirably, the internal gear 110 is kept in the round shape.

As the hardness of the external gear 120 is greater than that of the internal gear 110, the deformation of the external gear 120 is absorbed to a given degree through the internal gear 110, so that the lifespan of the external gear 120 or the internal gear 110 increases. In this case, the hardness of the external gear 120 is greater than that of the internal gear 110, which reliably increases the lifespan of the external gear 120.

In the step of turning the outer periphery, turning is carried out on the outer peripheral surface of the cylindrical portion 121 of the sintered molded body sintered in the sintering step.

In conventional practices, an inner periphery turning device and an outer periphery turning device are needed in a process of turning the inner and outer peripheries after forging, but according to the present invention, only the outer periphery turning is performed after the sintering, thereby minimizing the turning.

The cylindrical portion 121 of the external gear 120 should have a low thickness (e.g., in the range between 0.2 and 0.5 mm), and according to the present invention, the external gear 120 is made through the sintering so that turning is carried out on only the outer periphery of the cylindrical portion 121. That is, the inner periphery of the cylindrical portion 121 upon the sintering is sintered to a completed size, and the outer periphery of the cylindrical portion 121 that is relatively easy in machining has a size greater than a completed size, so that the external gear 120 is made through turning only on the outer periphery of the cylindrical portion 121.

Further, the inner periphery of the cylindrical portion 121 of the sintered molded body of the external gear 120 is made without any additional machining, thereby reducing material loss, and turning is carried out on only the outer periphery of the cylindrical portion 121 that is relatively easy in machining, thereby making it possible to achieve fast manufacturing.

In the step of machining the gear teeth of the external gear 120, the gear teeth 123 are machined on the outer periphery of the cylindrical portion 121 after the turning. After the step of machining the gear teeth 123, shot peening on the outer periphery of the external gear 120 is carried out.

The bearing 130 is coupled to the inner periphery of the external gear 120 made through the above-mentioned steps, and the outer peripheral surface of the external race 133 of the bearing 130 comes into contact with the sintered surface of the external gear 120, that is, the inner peripheral surface of the external gear 120.

The camshaft 140 is made through sintering, and it's manufacturing is completed through the sintering.

A sintering material, which is used to make the camshaft 140, contains 0.35 to 0.45% by weight of carbon (C), 1.4 to 1.8% by weight of nickel (Ni), 2.4 to 2.6% by weight of chromium (Cr), and the remaining percentage by weight of iron. The sintering material for making the camshaft 140 may selectively contain a trace element. In this case, a trace element (in an amount range of 0.01% by weight or less) such as vanadium (V) is present in the sintering material.

If carbon (C) is present in the sintering material in an amount range of less than 0.35% by weight, a density of a core may decrease upon heat treatment, and if carbon (C) is present in the sintering material in an amount range of greater than 0.45% by weight, impact resistance may decrease due to brittleness after the heat treatment.

If nickel (Ni) is present in the sintering material in an amount range of less than 1.4% by weight, desired harness and strength may not be obtained and corrosion resistance may decrease, and if nickel (Ni) is present in the sintering material in an amount range of greater than 1.8% by weight, brittleness may be generated to have low impact resistance and abrasion resistance may become deteriorated badly.

If chromium (Cr) is present in the sintering material in an amount range of less than 2.4% by weight, mechanical properties of the material may become deteriorated, and if chromium (Cr) is present in the sintering material in an amount range of greater than 2.6% by weight, a material cost may increase, formability may decrease, and upon sintering, chromium (Cr) may be oxidized.

The sintering material used to make the camshaft 140 is exemplary, and therefore, it may not be limited thereto.

A camshaft sintered molded body is made of the sintering material constituting the camshaft 140, and the sintering material is heated at a temperature in the range between 1180 and 1300° C. and thus sintered. If the sintering temperature is less than 1180° C, materials among powdered particles do not diffuse smoothly, and if the sintering temperature is greater than 1300° C., mass production may become deteriorated remarkably.

The rolling elements 135, the inner race 131, and the outer race 133 constituting the bearing 130 are made of bearing steel, carburized steel, etc. A method for manufacturing the bearing 130 is a well-known technology, and therefore, an explanation of the method will be avoided.

Referring to the hardness of the bearing 130, for example, the outer race 133 and the inner race 131 have hardness in the range between 58 and 62 HRc, and the rolling elements 135 have hardness in the range between 60 and 64 HRc.

The strain wave gear 100, which is made through the method for manufacturing the strain wave gear 100 according to the present invention, allows the internal gear 110 and the camshaft 140 to be completed in manufacturing by means of sintering, while allowing only the external gear 120 to be manufactured by means of turning on the outer periphery of the cylindrical portion 121 and machining of the gear teeth 120 after its sintering, and couples the internal gear 100, the camshaft 140, and the external gear 120 to the bearing 130, thereby finishing its manufacturing, so that quality variation of each part is low, fast manufacturing is achieved, and an amount of waste material in the manufacturing process is reduced to the maximum.

As mentioned above, the method for manufacturing the strain wave gear according to the present invention has been disclosed in the specification and drawings. However, this does not limit the invention within specific embodiments and it should be understood that the invention covers all the modifications, equivalents, and replacements within the idea and technical scope of the invention. It is therefore intended that the scope of the invention be limited not by this detailed description, but rather by the claims appended hereto.

### INDUSTRIAL APPLICABILITY OF INVENTION

The method for manufacturing the strain wave gear according to the present invention enables material loss to be greatly reduced, thereby making the strain wave gear at a low manufacturing cost, and allows cycle time in manufacturing the product to decrease, thereby making quality variation lowered to achieve easiness in mass production.

1. A method for manufacturing a strain wave gear comprising:
a ring-shaped internal gear (110) having gear teeth (115) on the inner periphery thereof and a plurality of through holes (113) in a circumferential direction thereof in such a way as to pass therethrough in an axial direction thereof; an external gear (120) having gear teeth (123) engaging with the gear teeth (115) of the internal gear (110); a camshaft (140) located inside the external gear (120) and having a wave generation portion (143) on the outer periphery thereof; and a bearing (130) located between the external gear (120) and the camshaft (140),
wherein the external gear (120) comprises a cylindrical portion (121) having the gear teeth (123) on the outer periphery thereof in such a way as to engage with the gear teeth (115) of the internal gear (110), a bottom (125) on the end portion of the cylindrical portion (121), and a protruding portion (127) protruding from the bottom (125) in an axial direction thereof,
the method comprising the step of manufacturing one or more of the internal gear (110), the external gear (120), and the camshaft (140) by means of sintering.

2. The method according to claim 1, wherein the internal gear (110), the external gear (120), and the camshaft (140) are manufactured by means of the sintering.

3. The method according to claim 2, wherein the internal gear (110) and the camshaft (140) are manufactured by means of the sintering, while the external gear (120) is manufactured by means of turning the outer peripheral surface of the cylindrical portion (121) of a sintered molded body after sintered and by means of machining of the gear teeth (123) on the outer peripheral surface thereof after the turning, so that the internal gear (110), the camshaft (140), and the external gear (120) are coupled to the bearing (130).

4. The method according to claim 1, wherein the internal gear (110) is manufactured by means of the sintering and made of a sintering material containing 0.35 to 0.45% by weight of carbon (C), 1.4 to 1.8% by weight of nickel (Ni), 2.4 to 2.6% by weight of chromium (Cr), and the remaining percentage by weight of iron, while selectively containing a trace element.

5. The method according to claim 1, wherein the external gear (120) is manufactured through steps of: sintering the sintering material to make the sintered molded body comprising the cylindrical portion (121), the bottom (125) on the end portion of the cylindrical portion (121), and the protruding portion (127) protruding from the bottom (125); turning the outer peripheral surface of the sintered molded body, and machining the gear teeth (123) on the outer peripheral surface of the cylindrical portion (121), and the bearing (130) is inserted into the inner peripheral surface of the cylindrical portion (121) on which the turning has been carried out.

6. The method according to claim 1, wherein the external gear (120) is manufactured by means of the sintering and made of a sintering material containing 0.35 to 0.45% by weight of carbon (C), 0.1 to 0.35% by weight of molybdenum (Mo), 2.4 to 2.6% by weight of chromium (Cr), and the remaining percentage by weight of iron, while selectively containing a trace element.

7. The method according to claim 5, wherein the external gear (120) is manufactured by means of the sintering and made of a sintering material containing 0.35 to 0.45% by weight of carbon (C), 0.1 to 0.35% by weight of molybdenum (Mo), 2.4 to 2.6% by weight of chromium (Cr), and the remaining percentage by weight of iron, while selectively containing a trace element.

8. The method according to claim 2, wherein the internal gear (110) has hardness in the range between 34 and 42 HRc, and the external gear (120) has hardness in the range between 38 and 46 HRc, which is higher than the hardness of the internal gear (110).
